(19) United States
(12) Patent Application Publication
(10) Pub. No.: US 2023/0044838 A1
(43) Pub. Date: Feb. 9, 2023

(54) MOBILE ELECTRIC VEHICLE CHARGING SYSTEM

(71) Applicants: Hyundai Motor Company, Seoul (KR); Kia Corporation, Seoul (KR)

(72) Inventor: Hyun Hoon SHIN, Yongin-Si (KR)

(73) Assignees: Hyundai Motor Company, Seoul (KR); Kia Corporation, Seoul (KR)

(21) Appl. No.: 17/869,548

(22) Filed: Jul. 20, 2022

(30) Foreign Application Priority Data
Aug. 3, 2021 (KR) 10-2021-0101900

(51) Int. Cl. B60L 53/54; H02J 7/00; H01M 8/04537

(52) U.S. Cl. CPC B60L 53/54; H02J 7/0048; H02J 7/00036; H02J 7/00712; H01M 8/04626; B60L 53/16

(57) ABSTRACT

A mobile electric vehicle charging system may include a fuel cell configured to generate electric power required to drive a vehicle, a main battery configured to store electric power generated by the fuel cell, a bidirectional power converter configured to control electric power input to and output from the main battery, a mobile charger configured to supply electric power to charge another vehicle, and a high-voltage junction box for divergence, configured to distribute electric power generated by the fuel cell to the bidirectional power converter and the mobile charger.

### CROSS-REFERENCE TO RELATED APPLICATION

The present application claims priority to Korean Patent Application No. 10-2021-0101900 filed on Aug. 3, 2021, the entire contents of which is incorporated herein for all purposes by this reference.

### BACKGROUND OF THE INVENTION

### Field of the Invention

The present disclosure relates to a mobile electric vehicle charging system configured for charging another electric vehicle with electric power generated by a fuel cell.

### Description of Related art

With increasing concern about environmental pollution, research on environmentally friendly energy sources has been actively conducted. There among, a fuel cell system using a fuel cell that generates electricity through electrochemical reaction between a fuel gas and an oxidizing gas as an energy source has attracted attention. Furthermore, a fuel cell vehicle provided with the fuel cell system is an important research target as a next-generation transportation means. The fuel cell vehicle drives an electric motor of the vehicle using electric power generated by the fuel cell.

There is recent demand for installation of a charger configured to supply electric power to the outside at a fuel cell vehicle including a secondary battery, such as a fuel cell and a high-voltage battery. To the present end, a separate external power supply (inverter) is connected to a DC output port provided at the fuel cell vehicle to supply an electric power of 220V/110V, or an external electric power supply system power circuit may be added so that an electric power of 220V/110V is directly supplied through an inverter mounted in the vehicle to be used.

In the case in which an electric power supply circuit for external electric power is connected to a bus end portion of a high-voltage battery in a divergence state in addition of the external electric power supply system, control for maintaining SOC value of the high-voltage battery is performed when conventional electric power distribution control is used, battery charging and discharging are repeatedly performed by electric power generated by the fuel cell, whereby efficiency decrease due to unnecessary charging and discharging occurs.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present disclosure are directed to providing a mobile electric vehicle charging system configured for charging another electric vehicle with electric power generated by a fuel cell, rather than electric power stored in a main battery of a fuel cell vehicle.

Various aspects of the present disclosure are directed to providing a mobile electric vehicle charging system. The mobile electric vehicle charging system includes a fuel cell configured to generate electric power required to drive a vehicle, a main battery configured to store electric power generated by the fuel cell, a bidirectional power converter configured to control electric power input to and output from the main battery, a mobile charger configured to supply electric power to charge another vehicle, and a high-voltage junction box for divergence, configured to distribute electric power generated by the fuel cell to the bidirectional power converter and the mobile charger.

According to various exemplary embodiments of the present disclosure, the mobile electric vehicle charging system may further include a fuel cell control unit configured to control distribution of electric power by the high-voltage junction box for the divergence, wherein the fuel cell control unit may determine whether to distribute electric power generated by the fuel cell to the mobile charger based on whether an electric vehicle charging mode entry condition is satisfied.

According to various exemplary embodiments of the present disclosure, the electric vehicle charging mode entry condition may include confirmation that the vehicle enters a charging preparation state and a charging gun of the mobile charger is connected to another electric vehicle.

According to various exemplary embodiments of the present disclosure, the vehicle charging preparation state may mean stoppage of driving in the state in which starting of the vehicle is on, an idle state, and a state in which the stage of a transmission is stage P.

According to various exemplary embodiments of the present disclosure, the fuel cell control unit may is configured to compare a required charging power amount of another electric vehicle with an available charging power amount of the fuel cell to determine an executable charging power amount.

According to various exemplary embodiments of the present disclosure, when the required charging power amount is equal to or greater than the available charging power amount, the fuel cell control unit may be configured to control the high-voltage junction box for divergence so that electric power generated by the fuel cell is supplied only to the mobile charger.

According to various exemplary embodiments of the present disclosure, when the required charging power amount is less than the available charging power amount, the fuel cell control unit may be configured to control the high-voltage junction box for divergence based on the required charging power amount and the available charging power amount so that electric power generated by the fuel cell is distributed to the mobile charger and the bidirectional power converter.

According to various exemplary embodiments of the present disclosure, when the electric vehicle charging mode entry condition is not satisfied, the fuel cell control unit may be configured to control the high-voltage junction box for divergence so that electric power generated by the fuel cell is supplied only to the bidirectional power converter.

According to various exemplary embodiments of the present disclosure, the mobile charger may include a first relay configured to interrupt or allow supply of current from the high-voltage junction box for the divergence, a power converter configured to convert current supplied from the fuel cell into current necessary to charge another electric vehicle, a second relay configured to interrupt surge of current converted by the power converter, and a charging gun configured to be connected to a charging port provided at another electric vehicle.

According to various exemplary embodiments of the present disclosure, a control unit of the mobile charger may be configured to transmit information related to whether the charging gun is connected to the charging port of another electric vehicle and information related to the required charging power amount of another electric vehicle to the fuel cell control unit configured to control the fuel cell.

According to various exemplary embodiments of the present disclosure, when a charging release mode entry condition is satisfied, the control unit of the mobile charger may be configured to transmit a signal informing that a charging release mode has been satisfied to the fuel cell control unit configured to control the fuel cell and may be configured to control the first relay to interrupt supply of electric power to another electric vehicle.

According to various exemplary embodiments of the present disclosure, a diode may be disposed between the mobile charger and the high-voltage junction box for the divergence, and the diode may be configured to interrupt flow of reverse current from the mobile charger to the fuel cell.

Other aspects and exemplary embodiments of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing a mobile electric vehicle charging system according to various exemplary embodiments of the present disclosure;

FIG. 2 is a block diagram showing a mobile charger according to various exemplary embodiments of the present disclosure;

FIG. 3 is a flowchart illustrating a charging process of supplying electric power to another electric vehicle according to various exemplary embodiments of the present disclosure; and

FIG. 4 is a flowchart illustrating a process of releasing the supply of electric power to the other electric vehicle according to various exemplary embodiments of the present disclosure.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Advantages and features of the present disclosure and methods for achieving the same will be clearly understood with reference to the following detailed description of embodiments However, the present disclosure is not limited to the exemplary embodiments disclosed herein and may be implemented in various different forms. The exemplary embodiments are merely provided to make the present disclosure of the present disclosure perfect and to perfectly instruct the scope of the present disclosure to those skilled in the art, and the present disclosure should be defined by the scope of claims. Like reference numbers refer to like elements throughout the specification.

The term “unit” or “module” used in the present specification signifies one unit that processes at least one function or operation, and may be realized by hardware, software, or a combination thereof.

In addition, the terms “first” and “second” are used in the present specification only to distinguish between the same elements, and the elements are not limited as to the sequence therebetween in the following description.

The above detailed description illustrates the present disclosure. Furthermore, the foregoing describes exemplary embodiments of the present disclosure. The present disclosure may be used in various different combinations, changes, and environments. That is, variations or modifications may be made within the conceptual scope of the present disclosure, equivalents to the present disclosure of the present disclosure, and/or the scope of technology and knowledge in the art to which various exemplary embodiments of the present disclosure pertains. The exemplary embodiments describe the best mode for realizing the technical concept of the present disclosure, and variations required for the concrete application and use of the present disclosure are possible. Therefore, the above detailed description does not limit the present disclosure disclosed above. Furthermore, the appended claims should be interpreted to include other embodiments.

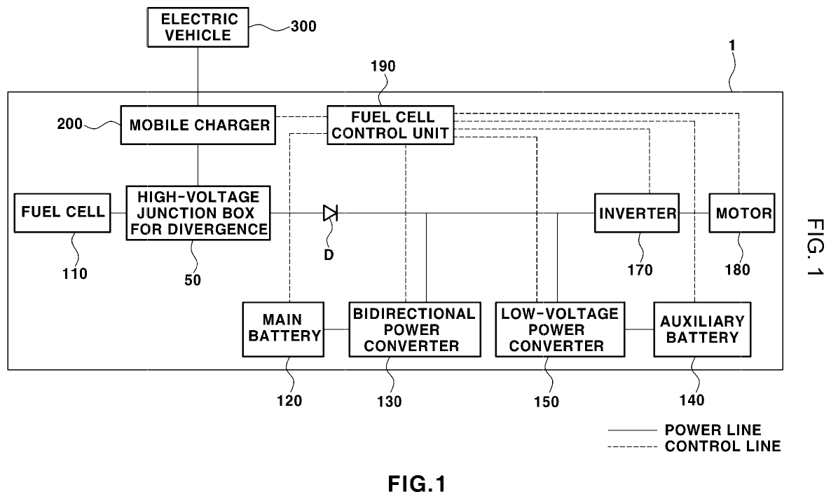

FIG. 1 is a block diagram showing a mobile electric vehicle charging system according to various exemplary embodiments of the present disclosure.

Referring to FIG. 1, the mobile electric vehicle charging system 1 may include a fuel cell 110, a high-voltage junction box 50 for divergence, a main battery 120, a bidirectional power converter 130, an auxiliary battery 140, a low-voltage power converter 150, an inverter 170, a motor 180, a fuel cell control unit 190, and a mobile charger 200. The mobile electric vehicle charging system 1 according to the exemplary embodiment of the present disclosure is a system applied to a vehicle provided with the fuel cell 110, and the vehicle may be a hydrogen fuel cell vehicle (HFCV). The mobile electric vehicle charging system 1 may be a system for charging another electric vehicle 300, rather than the vehicle provided with the fuel cell 110, with electric power generated by the fuel cell 110.

The fuel cell 110 may chemically react oxygen and hydrogen with each other to produce electrical energy (electric power). The fuel cell 110 may be a main power source that generates electric power required to drive the vehicle. To protect the fuel cell 110 from reverse current, a first diode D1 may be connected to the output end portion of the fuel cell 110.

The main battery 120 may store electrical energy (electric power) generated by the fuel cell 110. The motor 180 may be driven using the electrical energy stored in the main battery 120. For example, the main battery 120 may be a high-voltage battery. The fuel cell 110 and the main battery 120 may supply electric power required to drive the motor 180 of the vehicle. The fuel cell 110 may be used as a main power source of the fuel cell vehicle, and the main battery 120 may be used as an auxiliary power source of the fuel cell vehicle.

The bidirectional power converter 130 may control electric power output from the main battery 120 or electric power input to the main battery 120. The bidirectional power converter 130 may be a bidirectional high-voltage DC-DC converter (BHDC). The bidirectional power converter 130 may store electric power generated by the fuel cell 110 in the main battery 120. The bidirectional power converter 130 may convert voltage output from the main battery 120 into voltage required to drive the motor 180 and may transmit the converted voltage to the inverter 170. The bidirectional power converter 130 may convert voltage input to the main battery 120 into voltage required to charge the main battery 120.

The auxiliary battery 140 may store low-voltage power or may discharge stored electric power. The auxiliary battery 140 may supply electric power to low-voltage loads mounted in the vehicle. The auxiliary battery 140 may supply electric power to a plurality of control units and electronic parts mounted in the vehicle. For example, the auxiliary battery 140 may be a 12V, 24V, or 48V battery. However, the present disclosure is not limited thereto.

The low-voltage power converter 150 may convert high voltage received from the fuel cell 110 or the main battery 120 into low voltage and may charge the auxiliary battery 140 with the low voltage.

The inverter 170 may convert high-voltage DC power supplied from the fuel cell 110 and/or the main battery 120 into electric power required to drive the motor. For example, the inverter 170 may convert high voltage output from the fuel cell 110 and/or the main battery 120 into three-phase AC voltage.

The motor 180 may generate force necessary to drive the vehicle using electric power received from the inverter 170.

The mobile charger 200 may supply electric power necessary to charge the other electric vehicle 300. The mobile charger 200 may charge the electric vehicle 300 with electric power generated by the fuel cell 110. The mobile charger 200 may convert electric power generated by the fuel cell 110 into DC power and may charge a high-voltage battery mounted in the electric vehicle 300 with the DC power. The mobile charger 200, which is a construction mounted in the vehicle, may include a charging gun configured to be connected to a charging port of the other electric vehicle 300.

The high-voltage junction box 50 for divergence may be connected to the fuel cell 110. The high-voltage junction box 50 for divergence may be disposed on a high-voltage line that supplies electric power generated by the fuel cell 110 to the inverter 170. The high-voltage junction box 50 for divergence may distribute electric power generated by the fuel cell 110 to the bidirectional power converter 130 and the mobile charger 200. When the electric vehicle 300 is charged, the high-voltage junction box 50 for divergence may distribute electric power generated by the fuel cell 110 to the mobile charger 200. When the electric vehicle 300 is not charged, the high-voltage junction box 50 for divergence may distribute electric power generated by the fuel cell 110 to the bidirectional power converter 130. The bidirectional power converter 130 may charge the main battery 120 with electric power received through the high-voltage junction box 50 for divergence. Because the high-voltage junction box 50 for divergence is applied to the mobile electric vehicle charging system 1, an agent that supplies electric power to the mobile charger 200 may be the fuel cell 110, rather than the main battery 120.

A second diode D2 may be provided between the high-voltage junction box 50 for divergence and the mobile charger 200. The second diode D2 may be disposed at the input end portion of the mobile charger 200. The second diode D2 may protect the fuel cell 110 and the high-voltage junction box 50 for divergence from reverse current that flows to the fuel cell 110 and the high-voltage junction box 50 for divergence.

The fuel cell control unit 190 may control distribution of electric power by the high-voltage junction box 50 for divergence. The fuel cell control unit 190 may determine whether to distribute electric power generated by the fuel cell 110 to the mobile charger 200 based on whether an electric vehicle charging mode entry condition is satisfied. The electric vehicle charging mode entry condition may include confirmation that the vehicle enters a charging preparation state and the charging gun of the mobile charger 200 is connected to the other electric vehicle 300. The vehicle charging preparation state may mean stoppage of driving in the state in which starting of the vehicle is on, an idle state, and a state in which the stage of the transmission is stage P.

As various exemplary embodiments of the present disclosure, when the electric vehicle charging mode entry condition is satisfied, the fuel cell control unit 190 may control the high-voltage junction box 50 for divergence such that electric power generated by the fuel cell 110 is supplied to the mobile charger 200. At the instant time, when electric power generated by the fuel cell 110 is greater than electric power required by the electric vehicle 300, the fuel cell control unit 190 may control the high-voltage junction box 50 for divergence such that electric power generated by the fuel cell 110 is distributed to the bidirectional power converter 130 and the mobile charger 200.

As various exemplary embodiments of the present disclosure, when the electric vehicle charging mode entry condition is not satisfied, the fuel cell control unit 190 may control the high-voltage junction box 50 for divergence such that electric power generated by the fuel cell 110 is supplied to the bidirectional power converter 130.

According to the exemplary embodiment of the present disclosure, the main battery 120 may be excluded during a process of charging the electric vehicle with electric power generated by the fuel cell vehicle, and therefore it is not necessary to change logic that controls improvement in durability of the main battery 120 and the state of charge (SOC) value of the main battery 120. Furthermore, the mobile electric vehicle charging system 1 according to various exemplary embodiments of the present disclosure is implemented only by applying the high-voltage junction box 50 for divergence to the vehicle, whereby system simplification and cost reduction are achieved while system stability is improved.

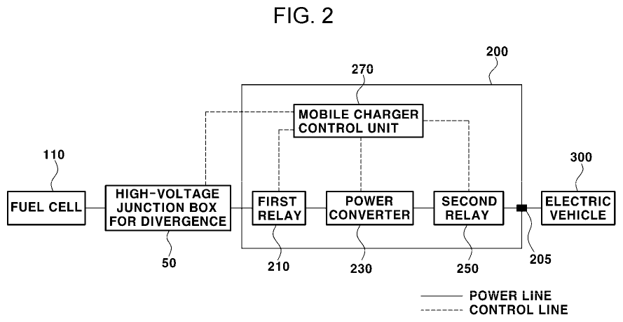

FIG. 2 is a block diagram showing a mobile charger according to various exemplary embodiments of the present disclosure.

Referring to FIG. 1 and FIG. 2, the mobile charger 200 may include a charging gun 205, a first relay 210, a power converter 230, a second relay 250, and a mobile charger control unit 270. However, the charging gun 205 may not be included in the mobile charger 200 and may be detachably attached to the mobile charger 200.

The first relay 210 may interrupt or allow the supply of current from the high-voltage junction box 50 for divergence. The first relay 210 may be controlled by the mobile charger control unit 270. When charging of the electric vehicle 300 is required, the first relay 210 may be turned on. When charging of the electric vehicle 300 is not required, the first relay 210 may be turned off.

The power converter 230 may convert current supplied from the fuel cell 110 into current necessary to charge the other electric vehicle 300. Current generated by the fuel cell 110 may be DC current, and current supplied to the electric vehicle 300 may be AC current. Consequently, the power converter 230 may convert DC current supplied from the fuel cell 110 into AC current.

The second relay 250 may interrupt surge of current converted by the power converter 230. The second relay 250, which is a construction necessary to protect the electric vehicle 300, may secure stability of current supplied to the electric vehicle 300.

The charging gun 205 may be connected to the charging port provided at the other electric vehicle 300. When the charging gun 205 is connected to the charging port provided at the other electric vehicle 300, information related to the state of the high-voltage battery mounted in the electric vehicle 300 may be determined by the mobile charger control unit 270.

The mobile charger control unit 270 may communicate with the fuel cell control unit 190, and may receive various kinds of information necessary for charging from the fuel cell control unit 190. The mobile charger control unit 270 may transmit information related to whether the charging gun 205 is connected to the charging port of the other electric vehicle 300 and information related to a required charging power amount of the other electric vehicle 300 to the fuel cell control unit 190. The required charging power amount of the electric vehicle 300 may be a power amount determined as a result of the charging gun 205 being connected to the charging port provided at the other electric vehicle 300 or input by a user.

As various exemplary embodiments of the present disclosure, when the vehicle enters the charging preparation state, the fuel cell control unit 190 may transmit a signal informing that the vehicle has entered the charging preparation state to the mobile charger control unit 270. Upon receiving the signal, the mobile charger control unit 270 may perform a charging mode. The mobile charger control unit 270 may check whether the charging gun 205 is connected to the charging port of the other electric vehicle 300, and may determine whether the electric vehicle charging mode entry condition is satisfied therethrough. Determination of the electric vehicle charging mode entry condition may be performed by at least one of the mobile charger control unit 270 and the fuel cell control unit 190.

As various exemplary embodiments of the present disclosure, the fuel cell control unit 190 may transmit information, such as a chargeable current value and a voltage value of a stack forming the fuel cell 110, to the mobile charger control unit 270. The chargeable current value may be the same parameter as an available charging power amount of the fuel cell 110. The available charging power amount may be determined by efficiency of the fuel cell 110, and may be changed depending on the state of charge (SOC) value of the main battery 120 mounted in the vehicle. In other words, the available charging power amount may be determined by the fuel cell control unit 190 in consideration of efficiency of the fuel cell 110 and the state of charge (SOC) value of the main battery 120.

As various exemplary embodiments of the present disclosure, the fuel cell control unit 190 may compare the required charging power amount of the other electric vehicle 300 with the available charging power amount of the fuel cell 110 to determine an executable charging power amount. Under a general situation, the executable charging power amount may be equal to the required charging power amount. Under a situation in which efficiency in electric power generation of the fuel cell 110 is lowered, however, the executable charging power amount may be less than the required charging power amount. When the required charging power amount is equal to or greater than the available charging power amount, the fuel cell control unit 190 may control the high-voltage junction box 50 for divergence such that electric power generated by the fuel cell 110 is supplied only to the mobile charger 200. When the required charging power amount is less than the available charging power amount, the fuel cell control unit 190 may control the high-voltage junction box 50 for divergence based on the required charging power amount and the available charging power amount such that electric power generated by the fuel cell 110 is distributed to the mobile charger 200 and the bidirectional power converter 130.

When a charging release mode entry condition is satisfied, the mobile charger control unit 270 may transmit a signal informing that a charging release mode has been satisfied. When the charging release mode entry condition is satisfied may be at least one of when the fuel cell 110 is abnormal, when connection between the charging gun 205 and the charging port of the electric vehicle 300 is released, when the mobile charger 200 performs charging by a charging amount required by the electric vehicle 300, when the user stops charging, when the vehicle is off, and when driving of the vehicle is started. The mobile charger control unit 270 may control the first DC relay 210 to interrupt the supply of electric power to the other electric vehicle 300. That is, when the charging release mode entry condition is satisfied, the first relay 210 may be turned off

According to the exemplary embodiment of the present disclosure, the fuel cell control unit 190 may compare the required charging power amount of the electric vehicle 300 with the available charging power amount of the fuel cell 110, and may distribute electric power generated by the fuel cell 110 to the mobile charger 200 and the bidirectional power converter 130. Consequently, it is possible to supply electric power to the mobile charger 200 while charging the main battery 120, whereby it is possible to prevent waste of electric power generated by the fuel cell 110.

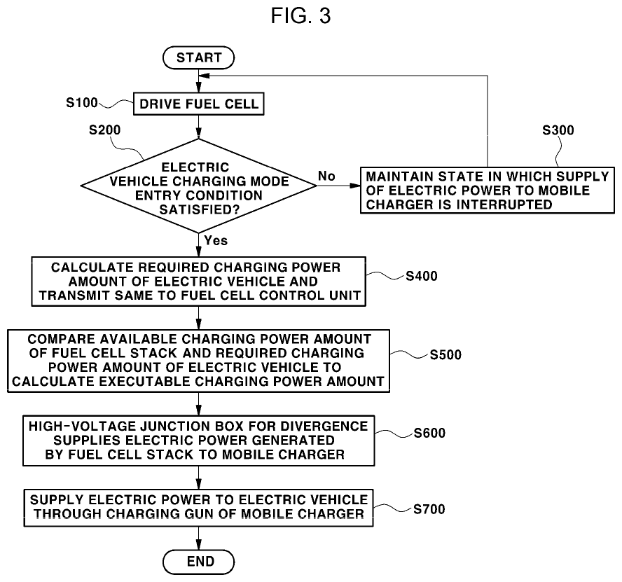

FIG. 3 is a flowchart illustrating a charging process of supplying electric power to the other electric vehicle according to various exemplary embodiments of the present disclosure. Duplicate description will be omitted for simplicity of description.

Referring to FIG. 1, FIG. 2, and FIG. 3, after starting of the vehicle is on, the fuel cell 110 may be driven. Electric power may be generated by driving of the fuel cell 110 (S100).

The fuel cell control unit 190 or the mobile charger control unit 270 may determine whether the electric vehicle charging mode entry condition is satisfied. The fuel cell control unit 190 may receive information related to whether the charging gun 205 is connected to the charging port of the other electric vehicle 300 from the mobile charger control unit 270, and determine whether the electric vehicle charging mode entry condition is satisfied based on the received information and whether the vehicle is in the charging preparation state (S200).

When the electric vehicle charging mode entry condition is not satisfied, the fuel cell control unit 190 may maintain the state in which the supply of electric power to the mobile charger 200 is interrupted. In other words, the fuel cell control unit 190 may control the high-voltage junction box 50 for divergence such that no electric power is distributed to the mobile charger 200. Furthermore, the fuel cell control unit 190 may transmit a signal informing that the electric vehicle charging mode entry condition is not satisfied to the mobile charger control unit 270. Upon receiving the signal, the mobile charger control unit 270 may control the first relay 210 to interrupt the supply of current to the mobile charger 200 (S300).

When the charging gun 205 is connected to the electric vehicle 300, the mobile charger control unit 270 may determine a required charging power amount of the electric vehicle 300 or may obtain information thereabout. The mobile charger control unit 270 may transmit the required charging power amount of the electric vehicle 300 to the fuel cell control unit 190 (S400).

The fuel cell control unit 190 may compare an available charging power amount of the fuel cell 110 and the required charging power amount of the electric vehicle 300 to determine an executable charging power amount. The fuel cell control unit 190 may transmit the executable charging power amount to the mobile charger control unit 270, and the mobile charger control unit 270 may charge the electric vehicle 300 based on the executable charging power amount. In other words, the fuel cell control unit 190 may control the high-voltage junction box 50 for divergence such that a power amount coinciding with the executable charging power amount is supplied to the mobile charger 200, or the mobile charger control unit 270 may control the first relay 210, the second relay 250, and the power converter 230 such that a power amount coinciding with the executable charging power amount is supplied to the electric vehicle 300 (S500 and S600).

Electric power may be supplied to the electric vehicle 300 through the charging gun 205 connected to the mobile charger 200 (S700).

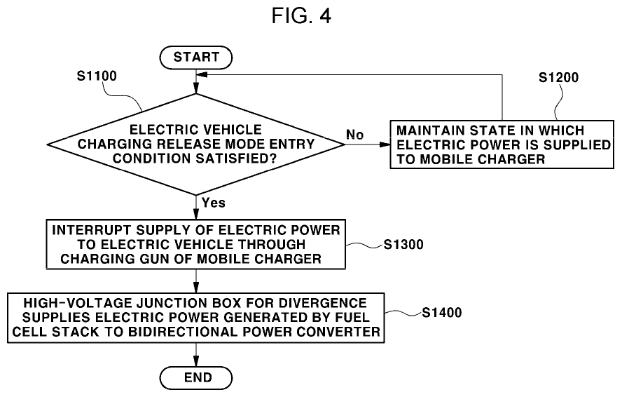

FIG. 4 is a flowchart illustrating a process of releasing the supply of electric power to the other electric vehicle according to various exemplary embodiments of the present disclosure.

Referring to FIGS. 1, 2, and 4, the fuel cell control unit 190 or the mobile charger control unit 270 may determine whether the electric vehicle charging release mode entry condition is satisfied (S1100).

When the electric vehicle charging release mode entry condition is not satisfied, the fuel cell control unit 190 may maintain the state in which electric power is supplied to the mobile charger 200 (S1200).

When the electric vehicle charging release mode entry condition is satisfied, the fuel cell control unit 190 may interrupt the supply of electric power generated by the fuel cell 110 to the mobile charger 200. Furthermore, the mobile charger control unit 270 may turn the first relay 210 off such that no electric power is supplied to the mobile charger 200 (S1300).

The fuel cell control unit 190 may control the high-voltage junction box 50 for divergence such that electric power generated by the fuel cell 110 is supplied to the bidirectional power converter 130. In other words, the fuel cell control unit 190 may charge the main battery 120 with electric power generated by the fuel cell 110 (S1400).

As is apparent from the foregoing, according to the exemplary embodiment of the present disclosure, because the high-voltage junction box for divergence is applied to the mobile electric vehicle charging system, an agent that supplies electric power to the mobile charger may be the fuel cell, rather than the main battery. That is, the main battery may be excluded during the process of charging the electric vehicle with electric power generated by the fuel cell vehicle, and therefore it is not necessary to change logic that controls improvement in durability of the main battery and the state of charge (SOC) value of the main battery. Furthermore, the mobile electric vehicle charging system according to various exemplary embodiments of the present disclosure is implemented only by applying the high-voltage junction box for divergence to the vehicle, whereby system simplification and cost reduction are achieved while system stability is improved.

According to the exemplary embodiment of the present disclosure, the fuel cell control unit may compare the required charging power amount of the electric vehicle with the available charging power amount of the fuel cell, and may distribute electric power generated by the fuel cell to the mobile charger and the bidirectional power converter. Consequently, it is possible to supply electric power to the mobile charger while charging the main battery, whereby it is possible to prevent waste of electric power generated by the fuel cell.

Furthermore, the term related to a control device such as “controller”, “control apparatus”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A mobile electric vehicle charging system comprising:
a fuel cell configured to generate electric power required to drive a vehicle;
a main battery configured to store electric power generated by the fuel cell;
a bidirectional power converter configured to control electric power input to and output from the main battery;
a mobile charger configured to supply electric power to charge another vehicle; and
a junction box for divergence, configured to distribute electric power generated by the fuel cell to the bidirectional power converter and the mobile charger.

2. The mobile electric vehicle charging system of claim 1, further including:
a fuel cell control unit configured to control distribution of electric power by the junction box for the divergence,
wherein the fuel cell control unit is configured to determine whether to distribute electric power generated by the fuel cell to the mobile charger based on whether an electric vehicle charging mode entry condition is satisfied.

3. The mobile electric vehicle charging system of claim 2,
wherein the electric vehicle charging mode entry condition includes confirmation that the vehicle enters a charging preparation state and a charging gun of the mobile charger is connected to another electric vehicle.

4. The mobile electric vehicle charging system of claim 3,
wherein the vehicle charging preparation state includes stoppage of driving of the vehicle in a state in which starting of the vehicle is on, an idle state, and a state in which a stage of a transmission in the vehicle is stage P.

5. The mobile electric vehicle charging system of claim 2,
wherein the fuel cell control unit is configured to compare a required charging power amount of another electric vehicle with an available charging power amount of the fuel cell to determine an executable charging power amount.

6. The mobile electric vehicle charging system of claim 5,
wherein, when the required charging power amount is equal to or greater than the available charging power amount, the fuel cell control unit is configured to control the junction box for the divergence so that electric power generated by the fuel cell is supplied only to the mobile charger.

7. The mobile electric vehicle charging system of claim 5,
wherein, when the required charging power amount is less than the available charging power amount, the fuel cell control unit is configured to control the junction box for the divergence based on the required charging power amount and the available charging power amount so that electric power generated by the fuel cell is distributed to the mobile charger and the bidirectional power converter.

8. The mobile electric vehicle charging system of claim 2,
wherein, when the electric vehicle charging mode entry condition is not satisfied, the fuel cell control unit is configured to control the junction box for the divergence so that electric power generated by the fuel cell is supplied only to the bidirectional power converter.

9. The mobile electric vehicle charging system of claim 1, wherein the mobile charger includes:
a first relay configured to interrupt or allow supply of current from the junction box for the divergence;
a power converter configured to convert current supplied from the fuel cell into current necessary to charge another electric vehicle;
a second relay configured to interrupt surge of current converted by the power converter; and
a charging gun configured to be connected to a charging port provided at another electric vehicle.

10. The mobile electric vehicle charging system of claim 9,
wherein a control unit of the mobile charger is configured to transmit information related to whether the charging gun is connected to the charging port of another electric vehicle and information related to a required charging power amount of another electric vehicle to a fuel cell control unit configured to control the fuel cell.

11. The mobile electric vehicle charging system of claim 9,
wherein, when a charging release mode entry condition is satisfied, a control unit of the mobile charger is configured to transmit a signal informing that a charging release mode has been satisfied to a fuel cell control unit configured to control the fuel cell and is configured to control the first relay to interrupt supply of electric power to another electric vehicle.

12. The mobile electric vehicle charging system of claim 1,
wherein a diode is disposed between the mobile charger and the junction box for the divergence, and
wherein the diode is configured to interrupt flow of reverse current from the mobile charger to the fuel cell.
